(19) United States
(12) Patent Application Publication
(10) Pub. No.: US 2025/0200139 A1
(43) Pub. Date: Jun. 19, 2025

(54) APPROXIMATING TIME TO BEST KNOWN SOLUTION CURVES BY PIECEWISE PREDICTIONS

(71) Applicant: Dell Products L.P., Round Rock, TX (US)

(72) Inventors: Ítalo Gomes Santana, Rio de Janeiro (BR); Miguel Paredes Quiñones, Campinas (BR); Diego Vrague Noble, Pelotas (BR)

(21) Appl. No.: 18/541,012

(22) Filed: Dec. 15, 2023

(51) Int. Cl. G06F 17/17

(52) U.S. Cl. CPC G06F 17/17

(57) ABSTRACT

Systems and methods for predicting or estimating time to solution in quantum computing system. A prediction engine is trained to estimate a time to best known solution curve associated with a quantum annealing system. Using the estimated or predicted curve, when a new QUBO or Ising model is to be executed, the time to best known solution can be predicted or estimated. An orchestration engine may select the quantum annealing system that has the best time to best known solution.

### FIELD OF THE INVENTION

Embodiments of the present invention generally relate to quantum computing systems including quantum annealing systems. More particularly, at least some embodiments of the invention relate to systems, hardware, software, computer-readable media, and methods for estimating or predicting a time to determine a solution for an optimization problem in a quantum annealing system.

### BACKGROUND

Quantum annealers are examples of quantum computing systems that are well suited for solving difficult problems such as, but not limited to, NP-hard or combinatorial problems. Quantum annealers generally use stochastic processes to minimize the energy for problem instances encoded, by way of example, as Quadratic Unconstrained Binary Optimization (QUBO) models. Ising models are also a way of encoding problem instances for quantum annealers and are equivalent to QUBO by a simple linear transformation. Due to the nature of quantum computing, independent runs of a QUBO in a quantum annealer may generate different solutions. Thus, analyzing the search effort performed by the quantum annealer and identifying a solution may require several runs.

The ability to identify a suitable solution can also be impacted by the time required to generate or identify that solution. More specifically, the time to solution (TTS) is a metric that uses the probability of success to measure the performance of the quantum annealer (or the quantum annealing algorithm). The time to solution measures the computational time that a quantum annealing system (or algorithm) requires to obtain a target solution with a certain probability.

Using optimal solutions as target solutions for time to solution experiments is problematic because these solutions are rarely available for large and relevant problem instances. Further, the computational burden required to prove their optimality is often prohibitive.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of the probability of success with respect to the time to solution, energy, and number of sweeps;

FIG. 2 discloses aspects of an orchestration system configured to execute or orchestrate the execution of quantum jobs and to estimate or predict the time required to find suitable solutions to the quantum jobs;

FIG. 3 discloses aspects of a piecewise method of determining or estimating a time to solution or a time to a best known solution;

FIG. 4 discloses aspects of collecting or generating training data for training a prediction engine;

FIG. 5 discloses aspects of training a prediction engine;

FIG. 6 discloses aspects of a method for estimating or predicting a time to best known solution; and

FIG. 7 discloses aspects of a computing device, system, or entity.

### DETAILED DESCRIPTION OF SOME EXAMPLE EMBODIMENTS

Embodiments of the present invention generally relate to quantum annealing systems and methods related to executing quantum jobs in quantum annealing systems. More particularly, at least some embodiments of the invention relate to systems, hardware, software, computer-readable media, and methods for approximating, estimating, or predicting a time to solution (TTS) or a time to a best known solution (TBKS) in a quantum computing environment such as a quantum annealing system.

Embodiments of the invention may be implemented in real or simulated quantum annealing systems. Simulated quantum annealing systems may be implemented in classical computing systems. Embodiments of the invention are discussed in the context of QUBOs, but are also applicable to Ising models and/or other quadratic binary models (QBMs).

Quantum annealing is often employed to solve problems such as combinatorial problems. These problems are often expressed in QUBO format or as QUBO models. A QUBO can be encoded or represented as follows:

$$H ( x ) = {\sum }_{i < j} {q}_{i , j} {x}_{i} {x}_{j} + {\sum }_{i} {q}_{i} {x}_{i}^{2} = {x}^{T} ,$$

where x∈{0,1}ⁿ. QUBO models are useful in part because they can represent a wide range of problems. When a QUBO is mapped to the qubits of a quantum computing such as a quantum annealing system, the quantum annealing system may progress to a low energy state. The solution is read from this low energy state.

A Hamiltonian is a function that represents the total energy of a physical system. A quantum annealing system is configured to interpolate between a static problem-independent Hamiltonian for which a ground state that can be prepared and a final Hamiltonian whose ground state yields the desired system. The quantum annealing system then linearly interpolates between H₀ and H_{f} (H_{f}=Q).

### Thus,

$$H ( t ) = α ( t ) {H}_{0} + β ( t ) {H}_{f} ,$$

where H_{f} is the Hamiltonian to be solved.

QUBOs and Hamiltonians are related. For example, problems represented as QUBOs may be mapped or associated to the Hamiltonian of a quantum annealer.

Quantum annealing includes various steps. For example, the initial problem or QUBO may be encoded and formulated as a Hamiltonian in one example. The Hamiltonian may be subject to an annealing schedule. The annealing schedule may include or involve some number of sweeps. Various hyperparameters of the quantum annealing system may be explored or changed as annealing executions are performed. Exploring each or different combination of hyperparameters guides the quantum annealer to an energy state that represents a solution to the optimization problem.

When solving a problem in a quantum annealing system, a user may be able to select a quantum annealing system from among available quantum annealing systems. Alternatively, an orchestration system may select a quantum annealing system for a quantum job based on various factors such as the time to solution or the time to best known solution.

Embodiments of the invention may be configured to determine or estimate the time to solution (TTS) or the time to the best known solution (TBKS) for each available quantum annealing system. In other words, the TTS or the TBKS may be estimated or predicted for each quantum annealing system that may be available. This may allow the orchestration system to select the fastest quantum annealing system. Because of the difficulty in proving that a particular solution is the optimum solution, embodiments of the invention relate to estimating the TBKS.

In one example, the TTS or TBKS is a metric that uses the probability of success to measure the performance of the quantum annealing system (or the quantum annealing algorithm). The probability of success Pₛ is defined in one example as follows:

$${P}_{s} = \frac{n}{R} ,$$

where n is the number of runs in which the target solution was obtained over R runs. A run generally refers to a complete execution to solve an instance of the input optimization problem. When performing a run, multiple iterations or sweeps may be performed. The number of sweeps performed from one run to the next run can vary.

By performing multiple annealing executions with different combinations of hyperparameter values in each annealing execution allows the hyperparameter spaces to be explored. During a sweep, hyperparameters may be constant such that solutions can be explored. Examples of hyperparameters that may be explored include annealing time, number of sweeps (the number of sweeps may be a hyperparameter for a single annealer execution), qubit coupling strength, transverse field strength, temperature parameters, initialization parameters, or the like. For example, different numbers of iterations or sweeps can be tested to progressively obtain better solutions until finding a target solution. In this manner, the probability of success in achieving a target solution can be increased by empirically exploring the hyperparameter space. To explore the hyperparameter space, multiple annealing executions may be performed and each annealing execution (or run) may include a different number of sweeps. For example, the quantum annealer may be read or sampled when a run is completed and prior to starting the run. Embodiments of the invention are able to determine an optimum or recommended number of sweeps. When determining the TTS or TBKS, the appropriate number of sweeps may be selected.

Embodiments of the invention explore solutions obtained or samples from the quantum annealer after each annealing execution. Because each annealing execution may use a different number of sweeps, this allows the solutions to be explored in the context of different hyperparameters (including number of sweeps) and allows the appropriate number of sweeps to be chosen for the TTS or TBKS.

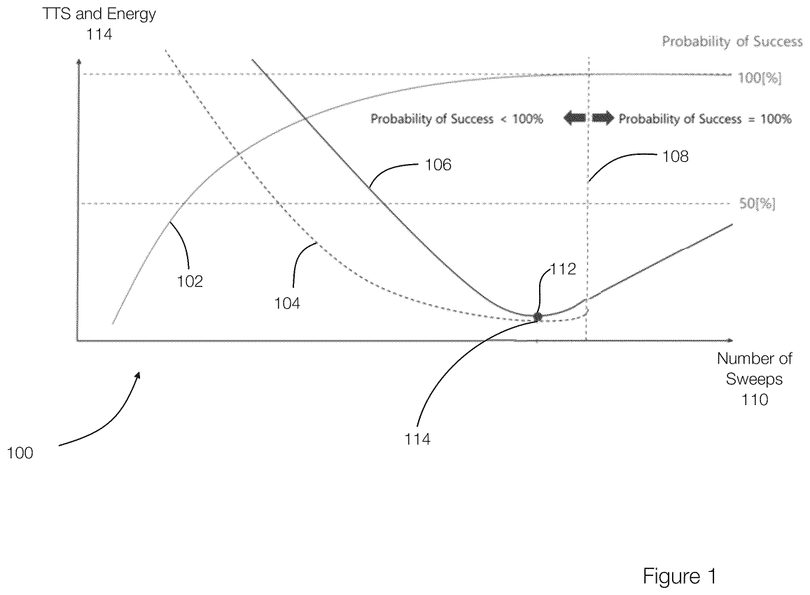

FIG. 1 generally illustrates a behavior of the time to solution for a given target solution. FIG. 1 illustrates a graph 100 describing a relationship between the number of sweeps 110 or iterations, number of samples, and the TTS and energy 114. As the number of sweeps 110 increases, the probability of success 102 also increases. FIG. 1 illustrates a minimum TTS (or TBKS) point 112 that is associated with a probability of success is less than but close to 100%. The minimum TTS, shown at point 112, essentially coincides with a minimum energy value at point 114 of the energy curve 104.

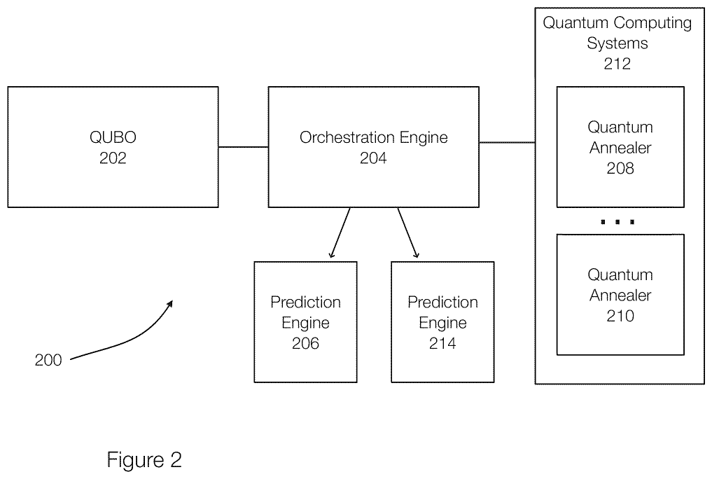

FIG. 2 discloses aspects of estimating a TTS or a TBKS. FIG. 2 illustrates an orchestration engine 204 that is included in a quantum orchestration system 200. The orchestration system 200 is generally configured to orchestrate the execution of quantum jobs, such as the QUBO 202. The orchestration engine 204 may include processors, memory, networking hardware, or the like. The orchestration engine 204 may receive a quantum job and generate the QUBO 202 or receive the QUBO 202 directly. The orchestration engine 204 May perform other aspects of quantum job orchestration such converting a QUBO to a graph, graph embedding, mapping the QUBO to qubits, or the like.

In addition, the orchestration 204 may generate an annealing schedule, read results of quantum execution in the quantum annealer 208, or other aspects of orchestrating the execution of the QUBO 202 in the quantum annealer 208. In this example, the orchestration system 200 includes or has access to multiple quantum computing systems 212, which are represented by the quantum annealers 208 and 210. The orchestration engine 204, when executing the QUBO 202, may select one of the quantum annealers (or other quantum computing systems) in the quantum computing systems 212 included in or available to the orchestration engine 204. The orchestration engine 203 may consider various factors for selecting a quantum annealer including, but not limited to, TBKS or TTS. Because the quantum annealer 208 is typically different from the quantum annealer 210, the corresponding TBKS may be different.

In this example, the orchestration engine 204 includes or has access to a prediction engine 206. The prediction engine 206 is configured to generate or predict an estimate of time required to generate a solution (e.g., a best known solution) to the job 202. More specifically, the prediction engine 206 may estimate or predict a time to solution or a time to best known solution for the QUBO 202. In one example, the orchestration system 200 may include a different prediction engine for each of the quantum annealers 208 and 210. Thus, the prediction engine 206 may estimate or predict a TBKS for the quantum annealer 208 and the prediction engine 214 may estimate or predict a TBKS for the quantum annealer 210.

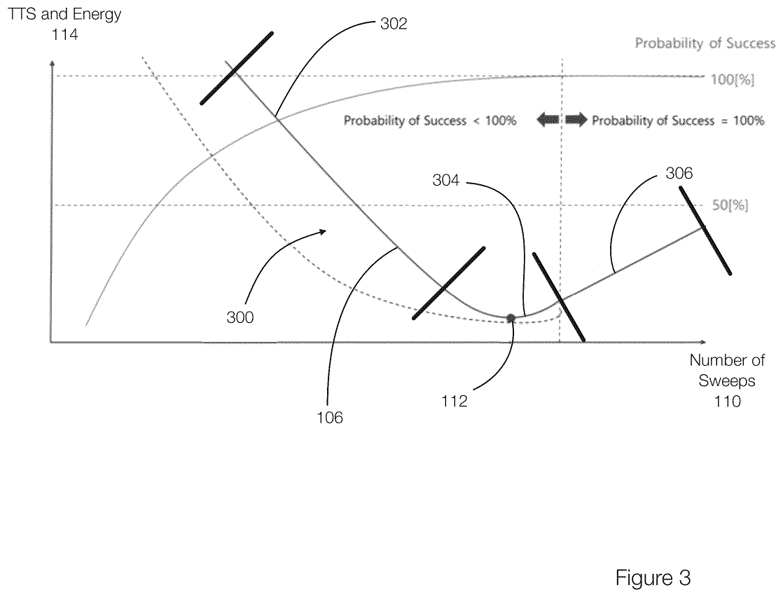

FIG. 3 discloses aspects of predicting or estimating a time to solution or a time to best known solution. Generally, embodiments of the invention collect data for a quantum annealer as QUBOs are executed. The collected data relates, in one example, to the TTS or TBKS. As illustrated in FIG. 3, the TBKS or TTS can be represented as a curve 300. The curve 300 can be represented in a piecewise manner. FIG. 3 illustrates an example of a curve 300 (the curve 106 in FIG. 1) that represents a TTS or a TBKS. The curve 300 may be represented as having three segments or pieces: a linear decrease curve or piece 302, a nonlinear valley curve or piece 304, and a linear increase curve or piece 306.

These pieces 302, 304, and 306 may be represented or constructed using regression techniques without losing generality. For example, the piece 302 may be represented or approximated by a linear function L1 (θₗ₁, x). The piece 304 may be represented by a quadratic function Q (θ_{g}, x). The piece 306 may be represented by a second linear function L2 (θₗ₂, x). This may generate a piecewise function, where x are the number of sweeps, diagonal of QUBO matrix, and mean values of QUBO coefficients. In one example, θₗ₁, θ_{q}, and θₗ₂ represent or stand for the parameters of the predictors L1, L2, and Q, which are examples of prediction engines. Embodiments of the invention may determine or estimate these curves or pieces for new or similar problems using the predictor engine or prediction engines once trained.

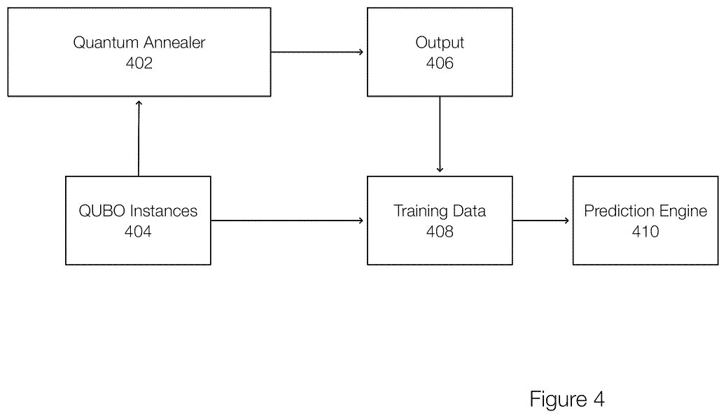

FIG. 4 discloses aspects of collecting or generating training data for training a prediction engine. FIG. 4 illustrates an example of a method for collecting training data. In this example, training data 408 is being collected for a quantum annealer 402. In this example, the prediction engine 410 is specifically trained to generate inferences or predictions for the quantum annealer 402. Other prediction engines may be trained for other quantum annealers in a similar manner. In one example, as a result, the prediction engine 410 is used to estimate or predict a TTS or TBKS specifically for the quantum annealer 402.

The training data 408 include data from both the input to the quantum annealer 402 and from the output 406 of the quantum annealer 406. In this example, the training data 408 is generated based on running or executing multiple QUBO instances 404. For each instance solved on the quantum annealer 402, information or data such as, but not limited to, number of qubits, mean value of QUBO coefficients, QUBO diagonal, or the like are collected. These are examples of inputs or data prior to execution of the QUBO.

Additional information for each instance includes the solution and execution times of the QUBO instances 404, the number of sweeps per read (in one example the number of reads is fixed). These are examples of data related to executing the QUBO or to the executed QUBO.

In one example, for each QUBO instance solved on different sweeps or using different numbers of sweeps, the best-known solution among all executions or runs on different number of sweeps is identified and using to determine the probability of success (Pₛ) and TBKS. The training data 408 thus includes information related to the QUBO from both an input and an output perspective.

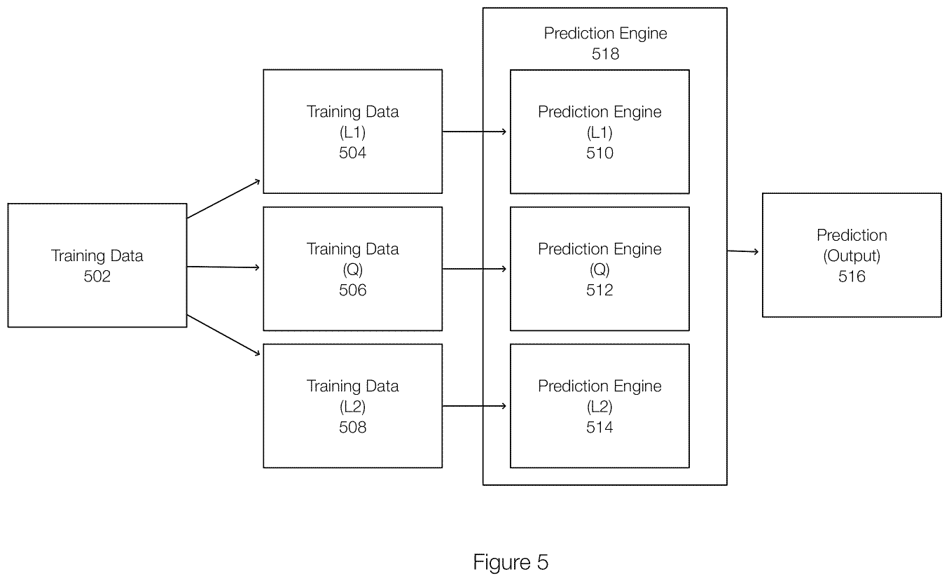

FIG. 5 discloses aspects of training a prediction engine. In FIG. 5, the training data 502, which is an example of the training data 408, is divided or separated into training data 504, 506, and 508. Each subset of the training data corresponds to a portion or piece of the TBKS curve 300. Thus, the training data 504 corresponds to the curve or piece 302, the training data 506 corresponds to the curve or piece 304, and the training data 508 corresponds to the curve or piece 306.

The prediction engine 518, which is an example of the prediction engine 410, may include prediction engines 510, 512, and 514. In this example, the prediction engine 510 is configured or trained to generate or predict the piecewise curve or piece 302 (L1), the prediction engine 512 is configured or trained to generate or predict the piecewise curve or piece 304 (Q), and the prediction engine 514 is configured or trained to generate or predict the curve or piece 306 (L2).

More specifically, the prediction engine 510, 512, and 514 may be trained to determine the general piecewise functions of the TBKS and the corresponding parameters θₗ₁, θ_{q}, and θₗ₂. Using these piecewise predicted or estimated functions or pieces, an orchestration engine may generate or estimate a time to obtain the best known solution—the TBKS. Thus, the output or prediction 516 may include the estimates of the TBKS pieces, parameters, and/or TBKS. In one example, the TBKS is determined from the prediction 516.

In one example, the similarity of hardness to solve a QUBO problem is based on the similarity of the diagonal of the QUBO, which is a vector of n entries used as input to the prediction engine 518 (or to each of the prediction engines 510, 512, and 514). By estimating these piecewise functions, the time to obtain the best known solution (e.g., TBKS) can be estimated or predicted with a certain probability.

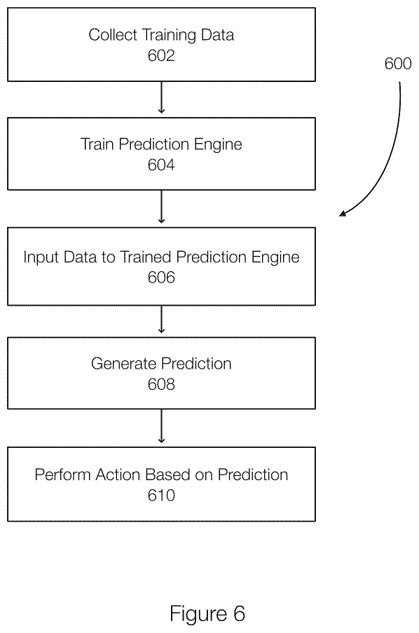

FIG. 6 discloses aspects of a method for estimating or predicting a time to best known solution. The method 600 may include aspects that may be performed separately or independently. The method 600, for example, illustrates a training phase and an operational phase. Initially, training data is collected 602 in the training phase. If predictions are to be generated for multiple quantum annealers, data related to each of the quantum annealers may be collected.

Next, the collected training data may be processed and separated into subsets. In one example, the training data is separated into three datasets: one for each portion or piece of a TBKS curve. Each of these training datasets are used to train a corresponding prediction engine. Thus, each of the prediction engines may predict or estimate portions or pieces of a curve, such as a TBKS curve.

The operational phase may include inputting data into the trained prediction engine. In one example, the same input is used for each of the trained prediction engines. The outputs, however, may correspond to different portions of the curve: one to the L1 curve, one to the Q curve, and one to the L2 curve. The predictions are generated 608 and may include the estimated piecewise functions. The piecewise functions may also be combined as part of the output.

The orchestration engine may then perform 610 an action based on the prediction. For example, the quantum annealer may be selected if the TBKS is within a specified time. In another example, predictions may be generated for multiple quantum annealers at the same time. This allows the orchestration engine to compare the TBKS times of multiple quantum annealers and select the fastest quantum annealer for the current QUBO instance. The execution can be added to the training data. The prediction engine may be retrained as necessary.

It is noted that embodiments of the invention, whether claimed or not, cannot be performed, practically or otherwise, in the mind of a human (e.g., too many solutions to test). Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, quantum annealing operations, heuristic operations, TTS or TBKS determination or estimation operations, orchestration operations, or the like or combinations thereof. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform various operations, including those described herein, which are initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM)

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, servers, and clients, for example, may likewise take the form of software, physical machines, containers, or virtual machines (VM), though no particular component implementation is required for any embodiment.

Example embodiments of the invention are applicable to any system capable of storing and handling various types of data or objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving an instance of a problem, inputting the instance of the problem into a prediction engine associated with a quantum annealer, generating an output, by the prediction engine, that relates to a time to best known solution curve, and estimating a time to best known solution for executing the instance of the problem in the quantum annealer.

Embodiment 2. The method of embodiment 1, wherein the prediction engine includes a first prediction engine, a second prediction engine, and a third prediction engine.

Embodiment 3. The method of embodiment 1 and/or 2, wherein the first prediction engine is configured to generate a first estimate of a first piecewise function, the second prediction engine is configured to generate a second estimate of a second piecewise, and the third prediction engine is configured to generate a third estimate of a third piecewise function.

Embodiment 4. The method of embodiment 1, 2, and/or 3, wherein the first piecewise function is a linear function, the second piecewise function is a quadratic function, and the third piecewise function is a linear function.

Embodiment 5. The method of embodiment 1, 2, 3, and/or 4, further comprising determining the estimate of the time to best known solution based on the first, second, and third piecewise functions.

Embodiment 6. The method of embodiment 1, 2, 3, 4, and/or 5, further comprising collecting training data for training the prediction engine.

Embodiment 7. The method of embodiment 1, 2, 3, 4, 5, and/or 6, wherein the training data includes input data and output data form multiple training instances, wherein the input data includes, for each of the training instances, number of sweeps, number of reads or samples, number of qubits, mean value of QUBO coefficients, and/or QUBO diagonal, and wherein the output data includes, for each of the training instances, solutions and times to best known solutions.

Embodiment 8. The method of embodiment 1, 2, 3, 4, 5, 6, and/or 7, further comprising estimating a time to best known solution using prediction engines that are associated with other quantum annealers.

Embodiment 9. The method of embodiment 1, 2, 3, 4, 5, 6, 7, and/or 8, further comprising selecting a particular quantum annealer by comparing the time to best known solution of the quantum annealer and the times to best known solution associated with the other quantum annealers.

Embodiment 10. The method of embodiment 1, 2, 3, 4, 5, 6, 7, 8, and/or 9, further comprising executing the instance in the particular quantum annealer and reading a solution from the particular quantum annealer.

Embodiment 11. The method as recited in any of embodiments 1-10 or any combinations of portions thereof.

Embodiment 12 A system, comprising hardware and/or software, operable to perform any of the operations, methods, or processes, or any portion of any of these, disclosed herein.

Embodiment 13 A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, engine, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

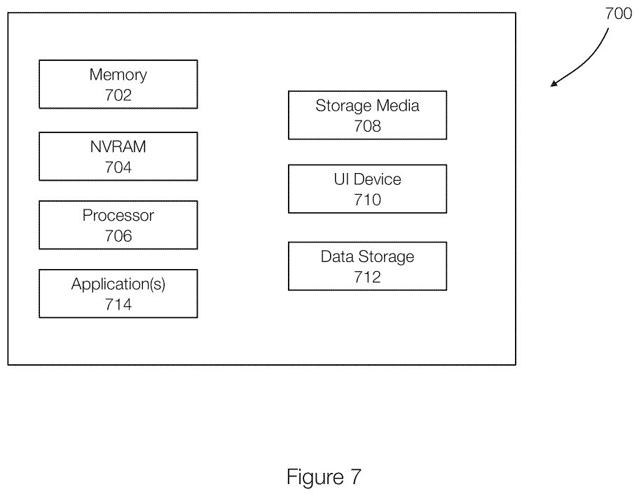

With reference briefly now to FIG. 7, any one or more of the entities disclosed, or implied, by the Figures, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein. The device 700 may alternatively represent an edge system, a cloud system/service, a distributed system, or the like.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The device 700 may also represent a computing system, a group of devices, or other computing system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving an instance of a problem;
inputting the instance of the problem into a prediction engine associated with a quantum annealer;
generating an output, by the prediction engine, that relates to a time to best known solution curve; and
estimating a time to best known solution for executing the instance of the problem in the quantum annealer.

2. The method of claim 1, wherein the prediction engine includes a first prediction engine, a second prediction engine, and a third prediction engine.

3. The method of claim 2, wherein the first prediction engine is configured to generate a first estimate of a first piecewise function, the second prediction engine is configured to generate a second estimate of a second piecewise, and the third prediction engine is configured to generate a third estimate of a third piecewise function.

4. The method of claim 3, wherein the first piecewise function is a linear function, the second piecewise function is a quadratic function, and the third piecewise function is a linear function.

5. The method of claim 4, further comprising determining the estimate of the time to best known solution based on the first, second, and third piecewise functions.

6. The method of claim 1, further comprising collecting training data for training the prediction engine.

7. The method of claim 6, wherein the training data includes input data and output data form multiple training instances,
wherein the input data includes, for each of the training instances, number of sweeps, number of reads, number of qubits, mean value of QUBO coefficients, and/or QUBO diagonal, and
wherein the output data includes, for each of the training instances, solutions and times to best known solutions.

8. The method of claim 1, further comprising estimating a time to best known solution using prediction engines that are associated with other quantum annealers.

9. The method of claim 8, further comprising selecting a particular quantum annealer by comparing the time to best known solution of the quantum annealer and the times to best known solution associated with the other quantum annealers.

10. The method of claim 9, further comprising executing the instance in the particular quantum annealer and reading a solution from the particular quantum annealer.

11. A non-transitory storage medium having stored therein instructions that are executable by one or more hardware processors to perform operations comprising:
receiving an instance of a problem;
inputting the instance of the problem into a prediction engine associated with a quantum annealer;
generating an output, by the prediction engine, that relates to a time to best known solution curve; and
estimating a time to best known solution for executing the instance of the problem in the quantum annealer.

12. The non-transitory storage medium of claim 11, wherein the prediction engine includes a first prediction engine, a second prediction engine, and a third prediction engine.

13. The non-transitory storage medium of claim 12, wherein the first prediction engine is configured to generate a first estimate of a first piecewise function, the second prediction engine is configured to generate a second estimate of a second piecewise, and the third prediction engine is configured to generate a third estimate of a third piecewise function.

14. The non-transitory storage medium of claim 13, wherein the first piecewise function is a linear function, the second piecewise function is a quadratic function, and the third piecewise function is a linear function.

15. The non-transitory storage medium of claim 14, further comprising determining the estimate of the time to best known solution based on the first second, and third piecewise functions.

16. The non-transitory storage medium of claim 11, further comprising collecting training data for training the prediction engine.

17. The non-transitory storage medium of claim 16, wherein the training data includes input data and output data form multiple training instances,
wherein the input data includes, for each of the training instances, number of sweeps, number of reads, number of qubits, mean value of QUBO coefficients, and/or QUBO diagonal, and
wherein the output data includes, for each of the training instances, solutions and times to best known solutions.

18. The non-transitory storage medium of claim 11, further comprising estimating a time to best known solution using prediction engines that are associated with other quantum annealers.

19. The non-transitory storage medium of claim 18, further comprising selecting a particular quantum annealer by comparing the time to best known solution of the quantum annealer and the times to best known solution associated with the other quantum annealers.

20. The non-transitory storage medium of claim 19, further comprising executing the instance in the particular quantum annealer and reading a solution from the particular quantum annealer.
